(19) United States
(12) Patent Application Publication
(10) Pub. No.: US 2024/0196484 A1
(43) Pub. Date: Jun. 13, 2024

(54) HEATING ATOMIZATION CORE

(71) Applicant: SHENZHEN HUACHENGDA PRECISION INDUSTRY CO., LTD., Shenzhen, Guangdong (CN)

(72) Inventor: Ping Chen, Shenzhen, Guangdong (CN)

(21) Appl. No.: 18/286,781

(22) PCT Filed: Jul. 30, 2021
(86) PCT No.: PCT/CN2021/109723

§ 371 Date: Oct. 13, 2023

(51) Int. Cl. H05B 3/06

(52) U.S. Cl. CPC H05B 3/06; H05B 2203/016; H05B 2203/021

(57) ABSTRACT

The present invention discloses a heating atomization core, comprising a liquid guide, a heat-ing body, and an electrode lead connected to the heating body; the heating body is attached to a surface of the liquid guide, the electrode lead extends outward from two ends of the heating body, and at least one electrode lead is provided with an insulating sheath; the liquid guide is externally provided with an axially extending housing, the liquid guide is cooperatively filled in the housing, and the housing is provided therein with a securing member for securing the electrode lead. The atomization core can protect a heating circuit and an electrode lead, can avoid short circuits, and allows for attaching a liquid guide and a heating body.

### TECHNICAL FIELD

The present invention relates to the technical field of atomization, and more specifically, to a heating atomization core.

### BACKGROUND

In the field of heat-generating atomization components, since the volume of the heating atomization assembly is small, the power supply generally uses the power between 2-4 V to supply power between 6-20 W, and the heating atomization needs to reach 200 degrees at the instantaneous temperature of suction, so that the heating circuit of the heating body is generally thin, which causes the heating body strength applied to the art to be poor, which is very easy to deform. In addition, the electrode lead is extended to connect with the battery. After the electrode lead is shaken by force, it will make the heating circuit of the heating body to shake together, resulting in poor contact between the conductive liquid and the heating element, which requires very high requirements for transportation and assembly. In addition, if the electrode lead wire touches the metal parts, it will cause an internal short circuit of the heating atomizing core.

In addition, the heat-generating atomization components currently used in this field are mainly divided into cotton cores and ceramic cores. The cotton cores have a good taste and are easy to obtain and cost-effective. The combination is intact, resulting in problems such as low atomization efficiency, incomplete atomization, and liquid leakage.

### SUMMARY

### Technical Problems

A technical problem to be solved by the present invention is, to provide a heating atomization core that can protect a heating circuit and an electrode lead, avoid a short circuit, and fit a heating body to a liquid guide, in response to the defects of the prior art.

### Solution of Problem

### Technical Solutions

A heating atomization core, comprising a liquid guide, a heating body, and an electrode lead connected to the heating body;
wherein the heating body is attached to a surface of the liquid guide, the electrode lead extends outward from two ends of the heating body, and at least one electrode lead is provided with an insulating sheath; the liquid guide is externally provided with an axially extending housing, the liquid guide is cooperatively filled in the housing, and the housing is provided therein with a securing member for securing the electrode lead.

Further, the housing is a straight pipe structure, and the side of the housing is provided with a liquid inlet hole or liquid inlet groove.

Further, the housing is a cylindrical frame structure.

Further, the middle or lower part of the electrode lead is bent and attached to the inner wall of the housing, the securing member fixes the electrode lead, and the securing member is provided with a vent hole.

Further, the outer periphery of the securing member is provided with a positioning slot, and the electrode lead is snapped in the positioning slot to be fixed.

Further, two positioning slots are provided, and two electrode leads are snapped in different positioning slots.

Further, a plurality of positioning slots are provided, the plurality of positioning slots are uniformly arranged on the outer periphery of the securing member, and the two electrode leads are snapped in any two of the plurality positioning slots.

Further, the upper part of the positioning slot is provided with a guide portion, the guide portion is smoothly transited from the top surface to the positioning slots, or the opening of the guide portion gradually narrows from the top to the bottom.

Further, the top surface of the positioning slot is an inclined surface or cambered surface that is high on the inside and low on the outside.

Further, the securing member is provided with a fixing hole through which the electrode lead is threaded.

Further, the shape of the securing member is consistent with the shape of the inner wall of the housing.

Further, the heating body is in the shape of a sheet, a cylinder or a spiral.

Further, the liquid guide is a multi-layer tubular structure made of overlapping layers of guide cotton.

### Beneficial Effect of the Invention

### Beneficial Effect

The present invention adopts the housing to support the liquid guide and the heating body, the liquid guide is not easy to collapse and deform due to the restraint of the housing, so that the liquid guide and the heating body form a good fit and the atomization effect can be improved. At least one electrode lead is equipped with an insulating sheath, which prevents the electrode lead from contacting with other metal components such as housing to cause a short circuit, while also enhancing the strength of the electrode lead and avoiding bending damage.

### BRIEF DESCRIPTION OF THE DRAWINGS

### Description of the Drawings

Subject matter of the present invention will be described in even greater detail below based on the exemplary figures. In the accompanying drawings:

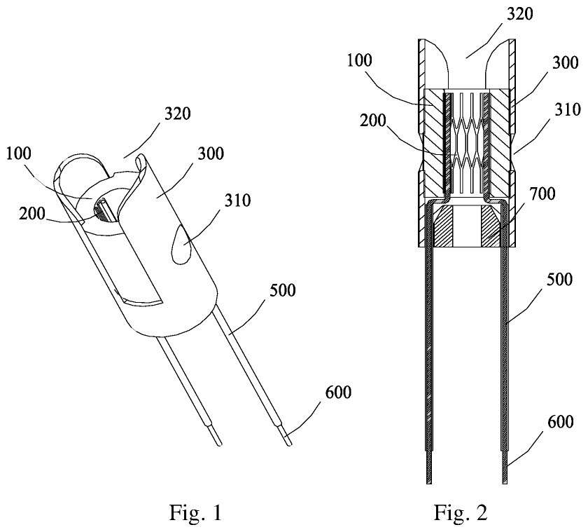

FIG. 1 is a schematic structural view of the first embodiment of the present invention;

FIG. 2 is a cross-sectional view of the first embodiment of the present invention;

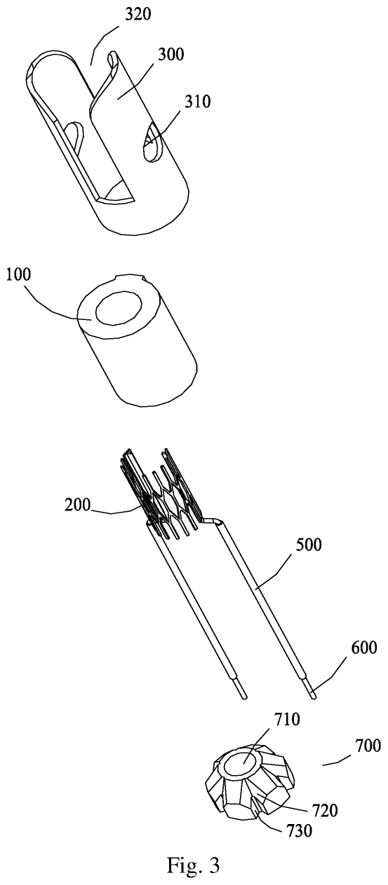

FIG. 3 is an exploded view of the first embodiment of the present invention;

FIG. 4 is an exploded view of the second embodiment of the present invention;

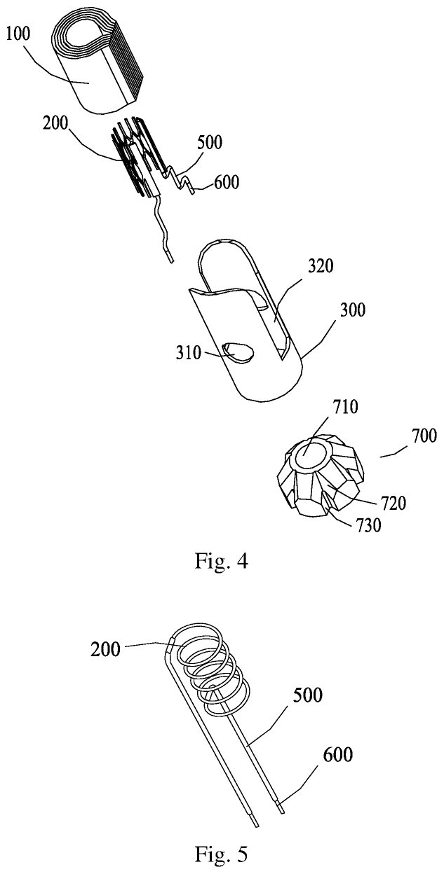

FIG. 5 is a schematic structural view of a heating body according to an embodiment of the present invention;

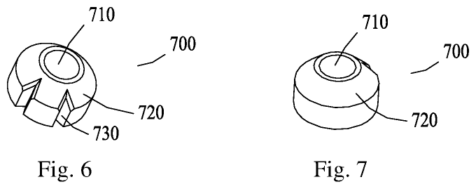

FIG. 6-7 are structural schematic diagrams of a securing member according to an embodiment of the present invention.

### DETAILED DESCRIPTION

### Description of the Invention

For better understanding of the technical features, objects and effects of the present invention, the specific embodiments of the present invention will be described in detail with reference to the accompanying drawings.

A component is said to be “fixed on” or “disposed on” another component, it can be directly or indirectly on the other component. When an element is referred to as being “connected to” another element, it can be directly or indirectly connected to the other element.

The terms “upper”, “lower”, “left”, “right”, “front”, “rear”, “vertical”, “horizontal”, “top”, “bottom”, “inner”, “outer”, etc. The indicated orientation or position is based on the orientation or position shown in the drawings, and is only for convenience of description, and should not be construed as a limitation on the technical solution. The terms “first”, “second” and so on are used for descriptive purposes only, and cannot be interpreted as indicating or implying relative importance or implicitly specifying the quantity of technical features. “Plurality” means two or more, unless otherwise clearly and specifically defined.

As shown in FIG. 1-FIG. 7, a heating atomizing core comprising a liquid guide 100, a heat-ing body 200, and an electrode lead 600 connected to the heating body 200; the heating body 200 is attached to a surface of the liquid guide 100, the electrode lead 600 extends outward from two ends of the heating body 200, and at least one electrode lead 600 is provided with an insulating sheath 500; the liquid guide 100 is externally provided with an axially extending housing 300, the liquid guide 100 is cooperatively filled in the housing 300, and the housing 300 is provided therein with a securing member 700 for securing the electrode lead 600. The axially extending housing 300 refers to forming a segment in the axial direction for radial constraint support of the liquid guide 100 and heating body 200.

As shown in FIG. 1-FIG. 4, the main function of the housing 300 of the present invention is to protect and support the liquid guide 100 and the heating body 200. The shape of the housing 300 matches the shapes of the liquid guide 100 and the heating body 200. The heating body 200 is in arc shape or cylindrical shape, the liquid guide 100 corresponds to a cylindrical structure, and the housing 300 is also a cylindrical structure.

The first embodiment of the housing 300 is: the housing 300 is a straight pipe structure, and the side of the housing 300 is provided with a liquid inlet hole 310 or liquid inlet groove for controlling the contact area between the liquid and the liquid guide 100 so as to control the liquid intake. Generally, the side of the housing 300 is provided with one liquid inlet hole 310 or one liquid inlet groove, or, the side of the housing 300 is provided with two liquid inlet holes 310 or two liquid inlet grooves.

Housing 300 adopts metal pipe, plastic tube, ceramic tube, etc. Housing 300 has relatively high requirements for temperature resistance, strength, and wall thickness, because housing 300 requires high temperature resistance, good strength, thin wall thickness, but also consider the low cost, so housing 300 is preferably made of metal pipes, such as stainless steel, or other metal processing surface treatment.

The second embodiment of the housing 300 is: the housing is a cylindrical frame structure. The frame structure can directly feed liquid into the gap of the frame without setting liquid inlet hole 310.

As shown in FIG. 1-FIG. 4, the liquid guide 100 is filled in the housing 300 and attached to the housing 300, as shown in FIG. 1-FIG. 3, liquid guide 100 is tubular structure made of guide cotton, and the liquid guide can also be a multi-layer tubular structure made of overlapping layers of guide cotton as shown in FIG. 4. The multiple layers of liquid guide cotton are overlapped and the interface of the multi-layer liquid guide cotton is inserted into the card slot 320 provided on the housing 300. Preferably, liquid guide 100 is made of overlapping layers of guide cotton, because a single layer of liquid guide 100 is soft and has poor support. Compared with the cotton core, the liquid guide 100 with multi-layer of guide cotton has a great improvement in liquid conduction uniformity and liquid transfer speed.

As shown in FIG. 1-FIG. 4, the heating body 200 is arranged in the liquid guide 100 and is composed of a heating section located in the middle and electrodes located at two ends. The heating body is in the shape of a sheet, a cylinder or a spiral. The sheet-shaped heating body 200 can be rolled into an unclosed cylindrical heating body 200.

Electrodes at two ends of heating body 200 are respectively connected with electrode lead 600, at least one electrode lead 600 is provided with an insulating sheath 500. In the present invention, insulating sheath 500 provided outside the electrode lead 600 is mainly to prevent a short circuit between two electrode leads 600, so if one of the electrode leads 600 has insulating sheath 500, the technical effect can be achieve. Therefore, the number of the electrode lead 600 with the insulating sheath 500 can be one or two. The installation position of the insulating sheath 500 at the electrode lead 600 requires that the insulating sheath 500 should be at least installed at the contact part between the electrode lead 600 and the housing 300. The reason is that the welding part of one end of the electrode lead 600 with the heating body 200 does not need to be provided with an insulating sheath 500, and at least at the end of the part of the electrode lead 600 extending out of the housing 300 has no insulating sheath 500 to connect with the battery.

Insulating sheath 500 acts as an insulating and prevents the heating body 200 from contacting the metal of the housing 300 causing a short circuit inside the heating atomization core, furthermore, the insulating sheath 500 has a micro-elasticity and can be clamped between the housing 300 and the securing member 700 to well fix the lead without pinch off the electrode lead 600. Only a short section of conductive wire core leaks from the end of the electrode lead 600, so that the electrode lead 600 exposed outside the heating body 200 will not cause short circuit, and the electrode lead 600 can be designed to be longer to facilitate welding with external batteries.

As shown in FIG. 1-FIG. 6, since the part of the electrode lead 600 protruding out of the housing 300 needs to be connected to the battery, and after the electrode lead 600 is forced to shake, the heating circuit of the heating body 200 will shake together, resulting in poor contact between the liquid guide 100 and the heating body 200, so it is necessary to fix the electrode lead 600 with the securing member 700 first. The middle or lower part of the electrode lead 600 is bent and attached to the inner wall of the housing 300. The securing member 700 is inserted into the housing 300 to fix the electrode lead 600. Specifically, the electrode lead 600 can be clamped and fixed between the securing member 700 and the inner wall of the housing 300, or an accommodating space can be provided on the securing member 700. The electrode lead 600 is clamped between the housing 300 and the securing member 700, so that shaking of the extended electrode lead 600 will not cause shaking of the heating body 200 and the heating circuit in the housing 300.

The shape of the securing member 700 is consistent with the shape of the inner wall of the housing 300.

There are several implementations of the securing member 700:

As shown in FIG. 1-FIG. 4 and FIG. 6, the first embodiment is as follows: the peripheral edge of the securing member 700 is provided with positioning slot 730 in which electrode lead 600 is clamped and fixed. The cross-sectional shape of the positioning slot 730 can be arc, U-shaped, V-shaped, square, etc. The cross-sectional shape of the positioning slot 730 can be preferably V-shaped, and the positioning slot 730 with a V-shaped cross-sectional shape has a large opening, which is easy for electrode lead 600 to insert and can completely clamp and fix the electrode lead 600. The number of the positioning slot 730 can be at least one. When the number of the positioning slot 730 is one, the positioning slot 730 can fix two electrode leads 600 together. As shown in FIG. 6, when two positioning slots 730 are provided, the two electrode leads 600 are clamped in different positioning slots 730. In addition, as shown in FIG. 3, a plurality of positioning slots 730 are arranged, and a plurality of positioning slots 730 are uniformly arranged on the outer periphery of the securing member 700, and two electrode leads 600 are clamped in any two of the plurality positioning slots 730. The upper part of the positioning slot 730 is provided with a guide portion 720, the guide portion 720 is smoothly transited from the top surface to the positioning slots 730, or the opening of the guide portion 720 gradually narrows from the top to the bottom. The electrode lead 600 slides into the positioning slot 730 along the guide portion 720. The top surface of the positioning slot 730 is an inclined surface or cambered surface that is high on the inside and low on the outside, which is also beneficial for the electrode lead 600 to slide toward two sides, so as to avoid pressing against the top surface of the securing member 700 during assembly. The securing member 700 can also clamp the electrode lead 600 between the securing member 700 and the inner wall of the housing 300 without setting the positioning slot. In this embodiment, the securing member 700 can be an elastic member.

In the second embodiment, the securing member 700 is provided with a through fixing hole, and the electrode lead 600 is inserted in the fixing hole.

The securing member 700 is provided with a vent hole 710, which passes through the inside of the housing 300 and the outside of the housing 300. And after the securing member 700 blocks the housing 300, the vent hole 710 can introduce air into the heating body 200. The shape and aperture of vent hole 710 are set according to actual needs and are not limited here.

After the liquid guide 100 of the heating body 200 is inserted into the housing 300, both the liquid guide cotton and the heating body 200 are fixed inside the housing 300 due to the restraint of the housing 300. Because the heating body 200 is made of metal, it will have an outward elastic force to make the heating body 200 and the liquid guide 100 contact well. When the securing member 700 is inserted into the housing 300, the electrode lead 600 is clamped between the housing 300 and the securing member 700. The shaking of the extended electrode lead 600 will not cause shaking of the heating body 200 and heating circuit inside the housing 300, avoiding the problem of shaking the heating circuit together after the electrode lead 600 is subjected to force shaking, and solving the problem of poor contact between the liquid guide 100 and the heating body 200.

1. A heating atomization core, comprising a liquid guide, a heating body, and at least one electrode lead connected to the heating body;
wherein the heating body is attached to a surface of the liquid guide, the at least one electrode lead extends outward from two ends of the heating body, and the at least one electrode lead is provided with an insulating sheath; the liquid guide is externally provided with an axially extending housing, the liquid guide is cooperatively filled in the housing, and the housing is provided therein with a securing member for securing the at least one electrode lead.

2. The heating atomization core of claim 1, wherein the housing is a straight pipe structure, the side of the housing is provided with a liquid inlet hole or liquid inlet groove.

3. The heating atomization core of claim 1, wherein the housing is a cylindrical frame structure.

4. The heating atomization core of claim 1, wherein the middle or lower part of the at least one electrode lead is bent and attached to the inner wall of the housing, the securing member fixes the at least one electrode lead, and the securing member is provided with a vent hole.

5. The heating atomization core of claim 4, wherein the outer periphery of the securing member is provided with at least one positioning slot, the at least one electrode lead is snapped in the at least one positioning slot to be fixed.

6. The heating atomization core of claim 5, wherein the at least one positioning slot comprises two positioning slots, and the at least one electrode lead comprises two electrode leads which are snapped in different positioning slots.

7. The heating atomization core of claim 5, wherein the at least one positioning slot comprises a plurality of positioning slots that are uniformly arranged on the outer periphery of the securing member, and the at least one electrode lead comprises two electrode leads which are snapped in any two positioning slots.

8. The heating atomization core of claim 5, wherein the upper part of the positioning slot is provided with a guide portion, the guide portion is smoothly transited from the top surface to the positioning slots, or the opening of the guide portion gradually narrows from the top to the bottom.

9. The heating atomization core of claim 1, wherein the top surface of the positioning slot is an inclined surface or cambered surface that is high on the inside and low on the outside.

10. The heating atomization core of claim 1, wherein the securing member is provided with at least one fixing hole through which the at least one electrode lead is threaded.

11. The heating atomization core of claim 1, wherein the shape of the securing member is consistent with the shape of the inner wall of the housing.

12. The heating atomization core of claim 1, wherein the heating body is in the shape of a sheet, a cylinder or a spiral.

13. The heating atomization core of claim 1, wherein the liquid guide is a multi-layer tubular structure made of overlapping layers of guide cotton.
